(19) United States
(12) Patent Application Publication
(10) Pub. No.: US 2002/0172036 A1
(43) Pub. Date: Nov. 21, 2002

(54) Automatic power generating device in combination with illumination lamps mounted to wheels

(76) Inventor: Highly Chien, Sih Lin District (TW)

Correspondence Address: DOUGHERTY & TROXELL, SUITE 1404, 5205 LEESBURG PIKE, FALLS CHURCH, VA, 22041, US

(21) Appl. No.: 09/859,435

(22) Filed: May 18, 2001

(51) Int. Cl. B60Q 1/00

(52) U.S. Cl. 362/192; 362/193; 362/500

(57) ABSTRACT

An electrical power generating device particularly adapted for mounting onto a rotary wheel can automatically produce electrical power to get LED lamps secured to the surface of wheels illuminated. The power generating device is an electrical motor having an output shaft and is fixed to the interior of a box. A speed retarding device including a counterweight or a wind operated wheel having a plurality of wind catching blades is attached to the output shaft of the motor so as to keep the shaft relatively still with respect to the motor rotated along with a rotating wheel. So, the motor serves as an electric generator producing electric power to get LED lamps illuminated. The LED lamps can be electrically actuated by way of such a power generating device on a vehicle moving on road.

### BACKGROUND OF THE INVENTION

The present invention relates to an electrical power generating device adapted for basically mounting onto a rotary object, and particularly to a wheel disc of vehicles to automatically produce electrical power to get LED lamps illuminated secured to the surface of wheels. The power generating device is an electric motor equipped with an output shaft and is fixed to the interior of a box. A speed reducing or retarding device including a counterweight or a wind operated wheel having a plurality of wind catching blades is attached to the output shaft of the motor so as to keep the shaft relatively still with respect to the electrical motor which is rotated along with a rotating wheel. In such a manner the motor is turned into an electric generator which can produce electric power to get LED lamps illuminated. Thereby the wheels can be automatically illuminated in the dark while moving on road so as to increasing driving safety.

It is commonly seen that at the front and rear end of vehicles are provided with various kinds of safety lights illuminating in the dark so as to effectively protect the vehicles from head-on or bumper collisions at night. However, the sides of vehicles are not so well illuminated in the dark that many traffic accidents result in side collisions. There are several prior arts used to solve such a problem by applying light reflection stickers or battery operated lights to the wheel discs of vehicles so as to effectively make the sides of vehicles visible in the dark when light is shed thereon. It can greatly increase driving safety and reduce accidental fatality on roads.

The battery operated lights attached to the wheel discs of vehicles are not durable in nature and must be maintained in a very short period of time by replacement of batteries. It is relatively expensive to maintain all the lights on four wheels to normally work all the time. Therefore, it is not economical to adopt such kind of auxiliary illumination.

### SUMMARY OF THE INVENTION

Therefore, the primary object of the present invention is to provide an electrical power generating device which is secured to the wheel discs of a vehicle and can automatically produce electrical power as long as a vehicle is on the move whereby various electrical appliance can be powered by such an electrical power generating device, such as the auxiliary illumination lights secured to the wheel discs.

Another object of the present invention is to provide an electrical power generating device which is an electrically operated motor having an output shaft to which a counterweight is attached so as to reduce the speed of the output shaft as close to zero as possible whereby the electrically operated motor can be turned into an electrical power generating device and outputs electrical power to various electrical appliance.

One further object of the present invention is to provide an electrical power generating device which is an electrically operated motor having an output shaft with which is engaged a wind operated wheel used to hold the output shaft of the motor in place as much as possible by wind produced during the movement of wheels of a vehicle. The electrical motor is secured to the surface of a wheel disc with its armature shelter and its output shaft limitedly housing in a vane mounted box so that the rotation of a wheel can turn the electrical motor into an electrical generator.

### BRIEF DESCRIPTION OF THE DRAWINGS

FIG. 1 is a perspective diagram showing a first embodiment of the present invention;

FIG. 2 is a front sectional diagram showing the assembly of the first embodiment thereof;

FIG. 3 is a side sectional diagram showing the first embodiment thereof wherein a counterweight is adopted as a speed retarding means;

FIG. 4 is a diagram showing the practical operation mode of the first embodiment mounted to a rotary wheel;

FIG. 5 is a perspective diagram showing the exploded components of a second embodiment of the present invention wherein a wind operated speed retarding means is used;

FIG. 6 is a front sectional diagram showing the air flow introduced into the wind operated speed retarding means as a wheel is rotated forwardly in an arrow indicated direction;

FIG. 7 is a diagram showing the distribution of wind catching vanes on the rear surface of the outer cover;

FIG. 8 is a sectional diagram showing the inner structure of the second embodiment thereof;

FIG. 9 is a diagram showing the practical application of the present invention to a vehicle's wheel.

### DETAILED DESCRIPTION OF THE PREFERRED EMBODIMENTS

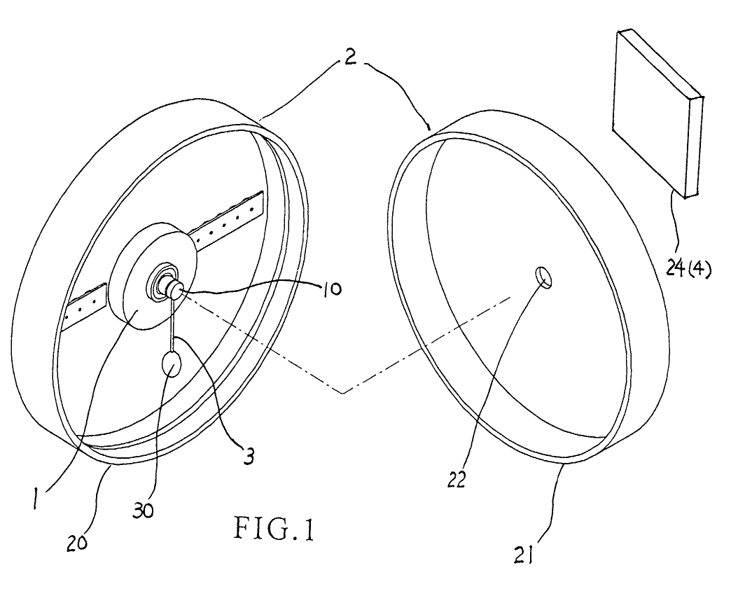

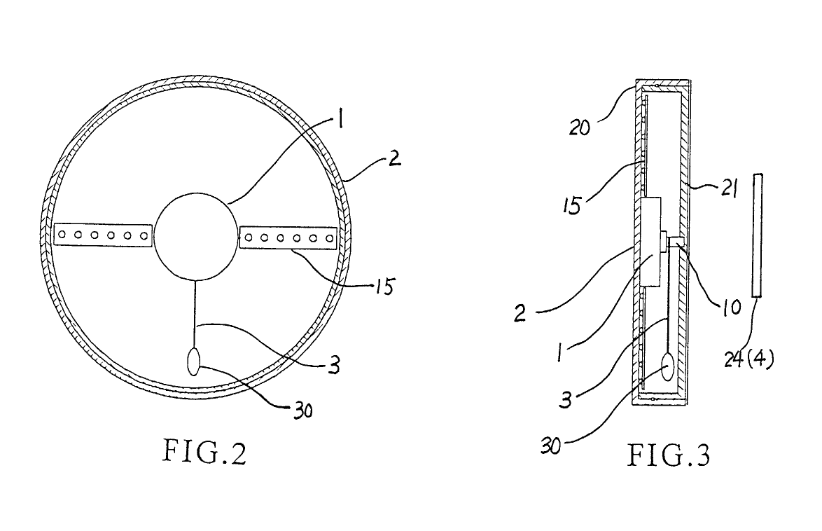

Referring to FIG. 1, the electrical power generating device is an electrical motor 1 in the present case, which is generally equipped with an output shaft 10 when viewed externally. The electrical motor 1 is secured to the inner surface of a housing box 2 which is made up of an outer cover 20 and an inner cover 21, as shown in FIG. 3. The inner cover 21 of the assembled housing box 2 is firmly attached to the surface of a wheel disc by way of a securing means 4, for instance, a double-sided adhesive sticker 24, as shown in FIG. 2.

It is commonly known that an electrical motor can deliver mechanical energy when electrical energy is supplied to the motor. However, if the motor is reversely operated, i.e., mechanical energy is transmitted either to the output shaft or the armature shelter case, it can be turned into an electrical power generating device and outputs electrical energy.

To effect such a purpose, in the first embodiment of the present invention, the output shaft 10 of the power generating electrical motor 1 is engaged with a speed retarding device 3, in this case, is a vertically suspended pendulum-like counterweight 30, fixed to the output shaft 10, which is theoretically adapted for stopping the output shaft 10 from rotation as much as possible. In contrast, the electrical motor 1 is firmly secured to the inner surface of the outer cover 20 can be simultaneously rotated with the wheel, but the counterweight 30 limited output shaft 10 is intended to be held relatively still whereby the electrical motor 1 can be turned into an electrical power generating device and output electrical energy.

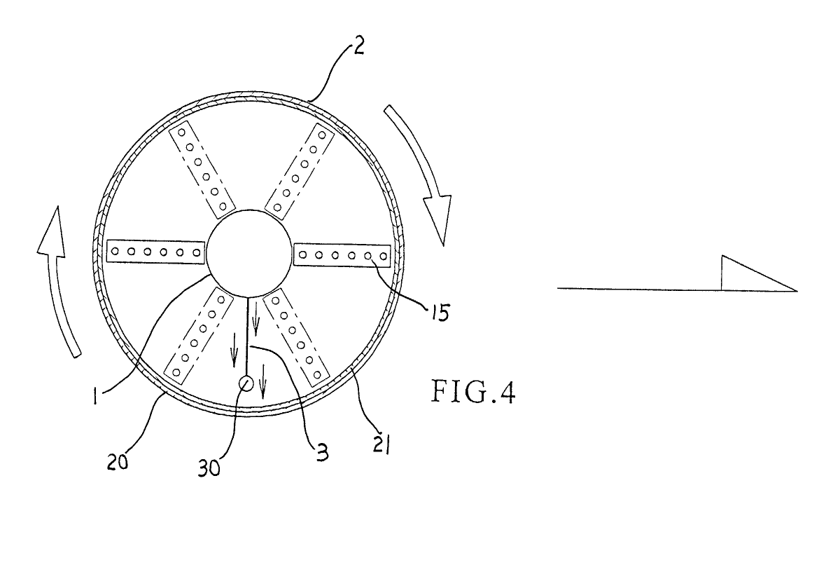

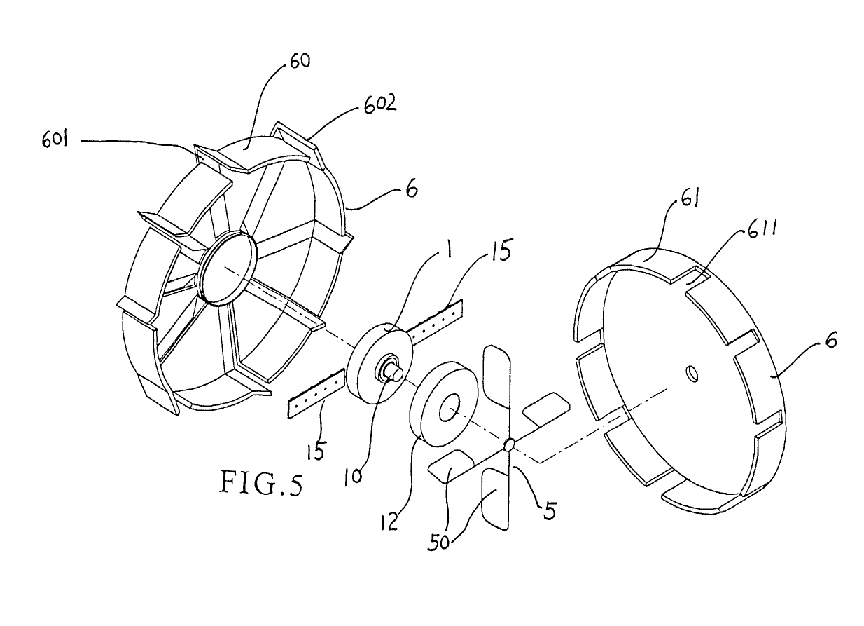

Referring to FIG. 4, in the second embodiment, the speed retarding counterweight 30 is replaced by a wind operated speed retarding wheel 5 equipped with a plurality of wind catching blades 50. The speed retarding wheel 5 is fixedly engaged with the output shaft 10 of the electrical motor 1. In this case, the output shaft 10 extends out of a first housing box 12 with the electrical motor 1 sealedly placed in the first housing box 12 and the wind operated speed retarding wheel 5 is housed in a second housing box 6.

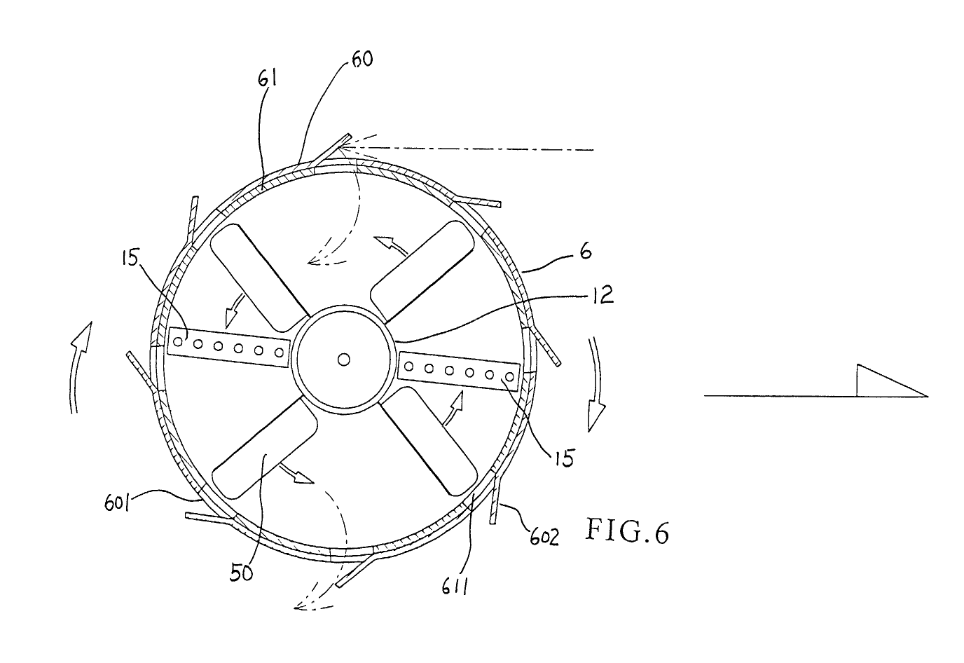

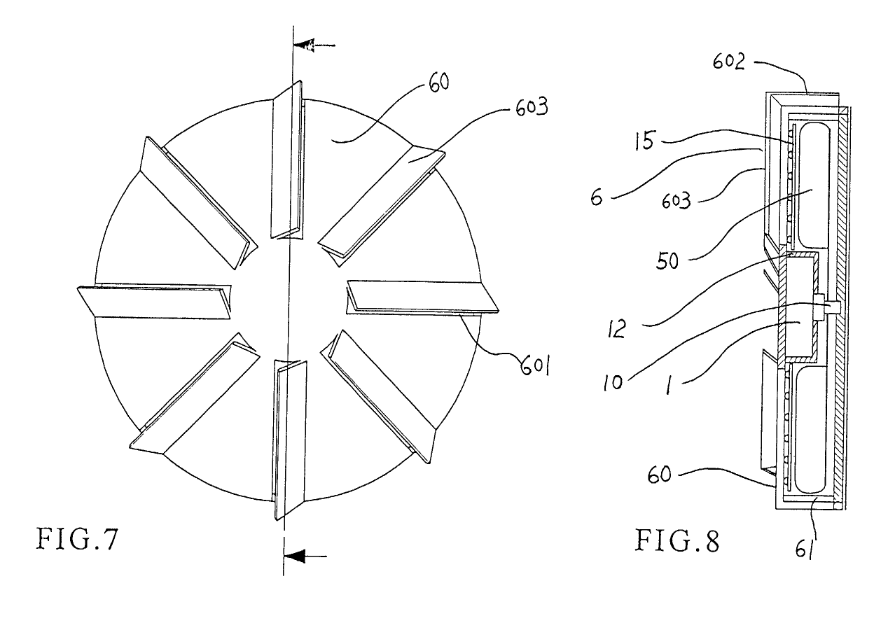

Referring to FIGS. 5, 6, 7, the second housing box 6 is made up of an outer cover 60 and an inner cover 61 that are snapped together in assembly. The outer cover 60 has a plurality of ventilation splits 601 axially distributed in equal distance on the vertically extended periphery of the outer cover 60. The ventilation splits 601 axially extend from the peripheral surface to the rear surface of outer cover 60 radially and each ventilation split 601 is provided with an axial wind catching flange 602 and a radial wind catching flange 603.

The inner cover 61 has a plurality of axially extended parallel ventilation openings 611 on the periphery thereof. In assembly, the outer cover 60 is engaged with the inner cover 61 with the ventilation splits 601 of the outer cover 60 positioned in alignment with the ventilation openings 611 of the inner cover 61 so as to permit air to be introduced into the second housing box 6.

As shown in FIG. 8, at the center of the inner cover 61 is provided with a recess 612 which is used to support the tip of the output shaft 10 in position. The ventilation splits 601 thereon for introduction of air into the second housing box 6 to effectively drive the speed retarding wheel 5 either to hold still or to rotate in a reverse direction with respect to the clockwise direction of rotation of a wheel 5 driven by wind. Thereby when the electrical motor 1 is firmly attached to the inner surface of the outer cover 60 of the second housing box 6, the motor 1 can simultaneously rotate along with a wheel of a vehicle but the speed retarding wheel 5 is forced by the introduced air to hold still or is further pushed to rotate in a reverse direction of the wheel. In such a manner the electrical motor 1 is transformed into an electrical generator.

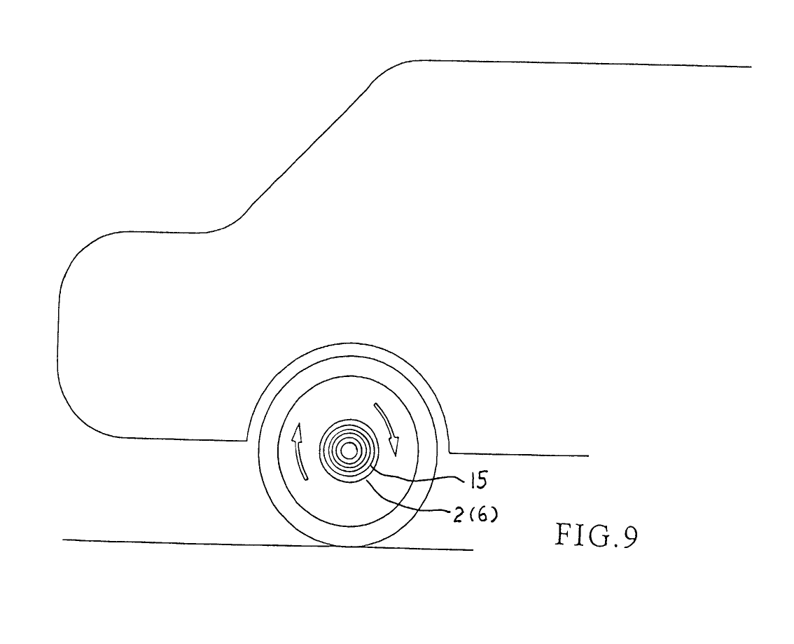

The automatic power generating device by way of rotation of vehicle's wheels illustrated in the first and second embodiments of the present invention can output electrical energy to various electrical appliance which can be a row of LED lamps 15 engaged with the electrical motor 1. The outer cover 60 is made of transparent plastic material so as to permit the light of LED lamps 15 to be shed out of the housing box 6. The assembled housing box 6 is secured to the external surface of a respective wheel disc of a vehicle's wheels whereby illumination of a vehicle's wheels on both sides thereof can increase the driving safety a vehicle. The row of LED lamps 15 can produce an effect of optical circles at night as a result of rotation of each wheel when visioned by people, as shown in FIG. 9.

In summary, the idea behind the present invention is to transform a general electrical motor into an electrical power generating device. It can be easily effected by keeping the output shaft of the electrical motor at least to hold still relative to its armature shelter case attached to a vehicle's wheel, or further to spin in a reverse direction by using a speed retarding device which can be a counterweight or a wind operated speed retarding wheel whereby electrical energy can be produced in such a simple way by such a common electrical motor.

I claim:

1. An automatic power generating device producing electrical energy by way of rotation of a wheel of a vehicle, comprising:
an electrical motor having an output shaft;
a housing box having an outer cover and an inner cover that are integrally engaged with each other for sealedly receiving said electrical motor and said a speed retarding means therein;
said speed retarding means being fixedly secured to said output shaft of said electrical motor for stopping said output shaft from rotation or making said the same reversely rotated with respect to said motor;
said housing box being secured to a center of a surface of a disc of a wheel by a securing means so as to permit said housing box to rotate with said wheel simultaneously;
whereby said output shaft is made not to rotate or to rotate in a reverse direction with respect to said electrical motor secured to a rotary wheel by way of said speed retarding means, resulting in electrical energy being produced and output via conduction wires coupled to said electrical motor.

2. The automatic power generating device as claimed in claim 1 wherein said speed retarding means is a counterweight vertically engaged with said output shaft and constantly maintained in a vertical position due to gravity.

3. The automatic power generating device as claimed in claim 1 wherein said speed retarding means is a wind operated wheel which is secured to said output shaft of said electrical motor which is housed in a first housing box; said wind operated wheel has a plurality of blades that are used to catch wind or air flow and is housed in a second housing box which is provided with ventilation openings to permit air to be introduced into said second housing box to drive said wind operated wheel secured to said output shaft of said electrical motor.

4. An automatic power generating device in combination with a plurality of illumination means mounted onto wheels of a vehicle, comprising:
an electrical motor having an output shaft;
a housing box having an outer cover and an inner cover that are integrally engaged with each other for sealedly housing said electrical motor and said a speed retarding means;
said speed retarding means being attached to said output shaft of said electrical motor for stopping said output shaft from rotation or making said the same reversely rotated with respect to said electrical motor secured to an inner surface of said housing box;
said housing box being secured to a center of a surface of a disc of a wheel so as to permit said housing box along with said electrical motor to rotate with said wheel simultaneously;
a plurality of illumination means being electrically coupled to said electrical motor by conduction wires;
whereby said electrical motor and said output shaft of said electrical motor are made to rotate in a reverse direction, resulting in electrical energy being produced and output via conduction wires to get said illumination means to illuminated.

5. The automatic power generating device in combination with a plurality of illumination as claimed in claim 4 wherein said speed retarding means is a counterweight vertically engaged with said output shaft and constantly maintained in a vertical position due to gravity.

6. The automatic power generating device in combination with a plurality of illumination means mounted onto wheel as claimed in claim 4 wherein said speed retarding means is a wind operated wheel which is secured to said output shaft of said electrical motor which is housed in a first housing box; said wind operated wheel has a plurality of blades that are used to catch wind or air flow and is housed in a second housing box which is provided with ventilation openings to permit air to be introduced into said second housing box to drive said wind operated wheel secured to said output shaft of said electrical motor.

7. The automatic power generating device in combination with a plurality of illumination means as claimed in claim 4 wherein said illumination means are a plurality of LED lamps.
